(19) United States
(12) Patent Application Publication
(10) Pub. No.: US 2011/0072701 A1
(43) Pub. Date: Mar. 31, 2011

(54) TAB ASSEMBLY FOR A CARD

(76) Inventor: Amber Annene Lemna, Jordan, MN (US)

(21) Appl. No.: 12/891,540

(22) Filed: Sep. 27, 2010

Related U.S. Application Data
(60) Provisional application No. 61/246,914, filed on Sep. 29, 2009.
(60) Provisional application No. 61/266,006, filed on Dec. 2, 2009.

(51) Int. Cl. G09F 3/10; B23P 19/00

(52) U.S. Cl. 40/638; 29/428

(57) ABSTRACT

A tab assembly includes a body having a first portion and a second portion. The first portion includes indicium. The second portion is oppositely disposed from the first portion and includes a first tab and a second tab. The first tab includes an outer surface and an oppositely disposed inner surface. The second tab includes an exterior surface and an oppositely disposed interior surface. The inner surface of the first tab faces toward the interior surface of the second tab. An adhesive layer is disposed on the inner surface of the first tab of the body and the interior surface of the second tab. A release liner is disposed over the adhesive layer on at least one of the inner surface of the first tab and the interior surface of the second tab.

### CROSS-REFERENCE TO RELATED APPLICATIONS

The present disclosure claims priority to U.S. Provisional Patent Application Ser. No. 61/246,914, entitled “Provisional Patent Application by Amber Annette Lemna et al. for A Tab Applied to Credit Cards, Debit Cards, Pictures, etc. for Easy Removal from Wallet or Other Holding Device” and filed on Sep. 29, 2009, and U.S. Provisional Patent Application Ser. No. 61/266,006, entitled “Tab Device and Method” and filed on Dec. 2, 2009, both of which are hereby incorporated by reference in their entirety.

### BACKGROUND

In today's society, wallets and purses are filled with personal cards such as credit cards, identification cards, etc. However, because of the number of personal cards a person carries and/or the holding device in which the personal card is placed, it can be difficult to remove those personal cards when needed.

### SUMMARY

An aspect of the present disclosure relates to a tab assembly including an indicia member, a first tab, a second tab, a release liner and an adhesive layer. The indicia member is attached to the first and second tabs. The first and second tabs are coated with an adhesive layer that is covered by at least one release liner.

Another aspect of the present disclosure relates to a tab assembly. The tab assembly includes an indicia member having a first end, an oppositely disposed second end. A first tab is engaged to the second end of the indicia member. A second tab is engaged to the second end of the indicia member. An adhesive layer coats at least a portion of the first tab and at least a portion of the second tab. A release liner covers the adhesive layer of at least one of the first and second tabs.

Another aspect of the present disclosure relates to a tab assembly. The tab assembly includes a body having a first portion and a second portion. The first portion includes indicium. The second portion is oppositely disposed from the first portion and includes a first tab and a second tab. The first tab includes an outer surface and an oppositely disposed inner surface. The second tab includes an exterior surface and an oppositely disposed interior surface. The inner surface of the first tab faces toward the interior surface of the second tab. An adhesive layer is disposed on the inner surface of the first tab of the body and the interior surface of the second tab. A release liner is disposed over the adhesive layer on at least one of the inner surface of the first tab and the interior surface of the second tab.

Another aspect of the present disclosure relates to a method of making a tab assembly. The method includes providing a substrate having a first portion and a second portion. The first portion includes a first axial end. The second portion includes a second axial end that is oppositely disposed from the first axial end. The substrate includes a first surface and an oppositely disposed second surface. The second surface includes an adhesive. An indicia member is positioned on the second surface of the substrate. The substrate is folded to a folded position in which the second surface of the first portion of the substrate faces in a direction toward the second surface of the second portion of the substrate. The second surfaces of the first and second axial ends are disconnected. The first axial end forms a first tab. The second axial end forms a second tab that is adjacent to the first tab in the folded position. A release liner is placed over the second surface of at least one of the first and second tabs.

A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### DRAWINGS

FIG. 1 is a perspective view of a tab device having exemplary features of aspects in accordance with the principles of the present disclosure.

FIG. 2 is a cross section view of a first tab end and a second tab end of FIG. 1, illustrating various layers of the cross section.

FIG. 3 is a cross section view of a first tab end and a second tab end of FIG. 1, illustrating various layers of the cross section.

FIG. 4A is a top view illustration of a portion of tab device prior to being folded.

FIG. 4B is a top view illustration of an adhesive release liner.

FIG. 4C is a side view illustration of the embodiments of FIG. 4A.

FIG. 5A is a perspective view of a tab assembly illustrating the tab in use on a card.

FIG. 5B is an end-on view of FIG. 5A.

FIG. 6 is a perspective view of a folder with the tab device of FIG. 1 of the present disclosure attached.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

In one embodiment the tab assembly of the present disclosure includes two opposable tabs hingedly attached to an indicia member. The opposable tabs can be coated with a pressure sensitive adhesive on adjacent surfaces. When the opposable tabs are coated with a pressure sensitive adhesive, the tab assembly can be located directly at a desired location. Once the tab assembly is located at the desired position, pressure can be applied to the surfaces of the tabs to adhere the tab assembly at the desired location. For example, the tab assembly can be located at the surface of the card and pressure applied to the surfaces of the tabs to adhere the tab assembly to the surface of the card. In yet other embodiments the card can be a credit card, a photograph, a driver's license, a debit card, a coupon, a club member card, a business card, a folder, a pocket folder and the likes.

In cases wherein the tab assembly is adhered to a specific location on a card, the indicia member extends from the surface of the object to which it is adhered to allow for visibility and ease of access of the particular item for grasping.

In some embodiments the indicia member includes a color. In other embodiments the indicia member can include a sign, a symbol, a trademark, a number, a letter, a design, other distinguishing marks, or combinations thereof. The indicia member can be used as an identifying mark. For example, a distinctive indicia member (for example, but not limited to a color) can be used as a tab on a credit card and the same distinctive indicia member can be used as a tab on the corresponding file folder or file pocket to organize receipts generated from charges on that credit card. In other embodiments the indicia member can include a trademark that relates to the card or photo to which the indicia member is attached. In yet other embodiments, the indicia member can include an insignia which relates to the debit card to which the indicia member is attached.

In some embodiments the indicia member can include a bead, a button, a rhinestone, a stud, a rivet or the likes. The indicia member comprising a bead, a button, a rhinestone, a stud, a rivet or the like can enhance the grippability of the tab assembly when being gripped by the fingers of a human. The added three dimensionality of the indicia member described above reduces the chance of the fingers slipping off of the tab assembly when the tab assembly is, for example, adhered to a credit card and used to retrieve the credit card from a wallet.

The tab assembly additionally allows for easy identification of the card. For example, when a credit card is inserted into the pocket of a wallet, the identity of the credit card cannot be easily determined without first removing the credit card from the pocket of the wallet because the pocket obscures the face of the credit card. The tab assembly allows for a user to determine the identity of the credit card immediately upon opening the wallet, eliminating the need to physically remove the card from the wallet pocket.

In some embodiments, the tab assembly also acts as a convenient means for gripping the card when the card is inserted into a pocket or a wallet. In other embodiments, the tab assembly can be used to identify and more easily retrieve credit cards when several credit cards are stacked together and secured, for example, with a rubber band, a rubber binder or an elastic band. In one embodiment, multiple tab assemblies can be located on and attached to multiple credit cards to allow for all of the tab assemblies to be seen at a glance.

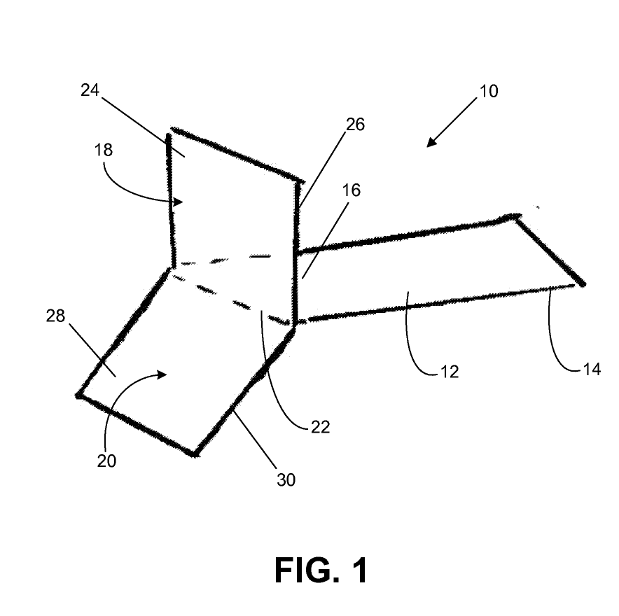

Referring now to FIG. 1, a tab assembly 10 is shown. The tab assembly 10 includes an indicia member 12 having a first end 14 and a second end 16. In one embodiment, the indicia member 12 includes any one or more of a color, a pattern, a figure, a shape, a logo, a symbol, a letter, and a number. In another embodiment, the indicia member 12 includes one of a jewel, a gem, a rhinestone, a button, a bead, a rivet and a stud.

The tab assembly 10 further includes a first tab 18 and a second tab 20 engaged to the second end 16 of the indicia member 12. In the depicted embodiment, the first and second tabs 18, 20 are engaged to opposite surfaces of the indicia member 12. In the depicted embodiment, a hinge 22 is formed between the indicia member 12 and the first and second tabs 18, 20.

The first tab 18 includes an inner surface 24 and an oppositely disposed outer surface 26. The second tab 20 includes an interior surface 28 and an oppositely disposed exterior surface 30. The first and second tabs 18, 20 are configured so that the inner surface 24 of the first tab 18 faces in a direction toward the interior surface 28 of the second tab 20 so that the inner surface 24 and the interior surface 28 face toward each other.

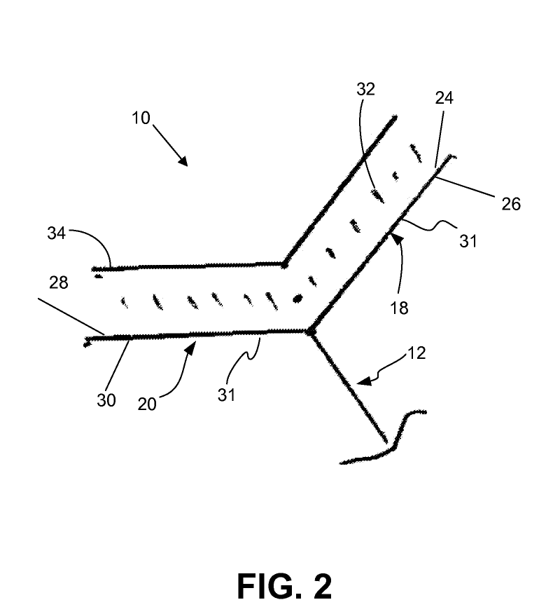

Referring now to FIG. 2, a cross section of the tab assembly 10 is shown. In the depicted embodiment, each of the first and second tabs 18, 20 of the tab assembly 10 includes a substrate 31. The tab assembly 10 further includes an adhesive layer 32. The adhesive layer 32 coats at least a portion of the first and second tabs 18, 20. In the depicted embodiment, the adhesive layer 32 coats the inner surface 24 of the first tab 18 and the interior surface 28 of the second tab 20. The adhesive layer 32 allows the tab assembly 10 to be secured to a desired location (e.g., a card, a file folder, etc.).

In the depicted embodiment, the tab assembly 10 further includes a release liner 34. The release liner 34 is adapted to cover the adhesive layer 32 of at least one of the first and second tabs 18, 20 so that the adhesive layer 32 resides between the substrate 31 and release liner 34. In the depicted embodiment, the release liner 34 covers the inner surface 24 of the first tab 18 and the interior surface 28 of the second tab 20.

To secure the tab assembly 10 to another object, the user removes the release liner 34 from first tab 18 and second tab 20 and presses the adhesive layer 32 against the object by applying a force at the outer surface 26 of the first tab 18 and the exterior surface 30 of the second tab 20. In one embodiment, the adhesive layer 32 can include a pressure-sensitive adhesive. Classes of suitable pressure-sensitive adhesives include acrylics, tackified rubber, tackified synthetic rubber, ethylene vinyl acetate, silicone, and the like. The adhesive may be applied directly to the tab assembly 10 such as with a hot-melt adhesive coating process. The adhesive may also be applied in the form of a transfer tape (using for example, Scotch™ adhesive Transfer Tape 924, available from the 3M Company, St. Paul, Minn.).

The substrate 31 can comprise paper, plastic and combinations thereof. In some embodiments the substrate 31 thickness can be in the range of from about 0.01 mm to about 2.00 mm. In other embodiments the substrate 31 thickness can be in the range of from about 0.05 mm to about 1.5 mm, 0.1 mm to about 1.0 mm or even in some embodiments in the range of from about 0.2 mm to about 0.8 mm.

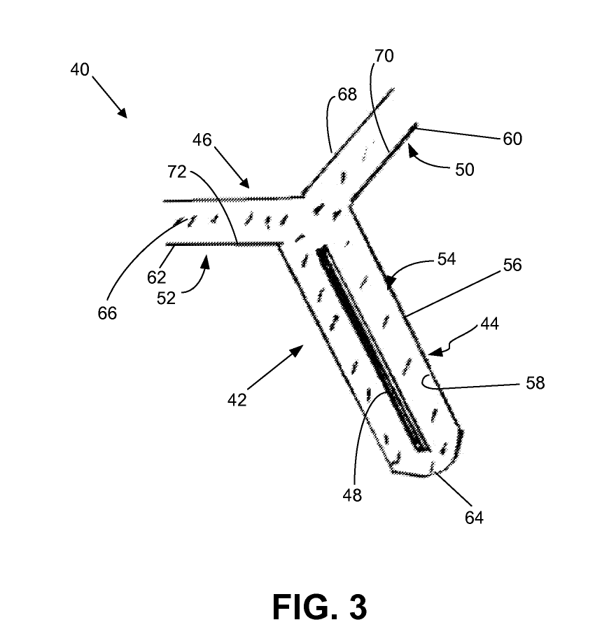

Referring now to FIG. 3, an alternate embodiment of a tab assembly 40 is shown. The tab assembly 40 includes a body 42 having a first end portion 44 and an oppositely disposed second end portion 46. The first end portion 44 includes indicium (e.g., a color, a pattern, a figure, a shape, a logo, a symbol, a letter, a number, etc.). In the depicted embodiment, the indicium is disposed on an indicia member 48. The second end portion 46 includes a first tab 50 and a second tab 52.

In some embodiments the indicia member 48 has a thickness in the range of from about 0.1 mm to about 2.00 mm. In other embodiments the indicia member 48 has a thickness in the range of from about 0.2 mm to about 1.5 mm, 0.3 mm to about 1.0 mm or even in some embodiments of from about 0.5 mm to about 0.8 mm.

The body 42 is formed from a substrate 54 having a first surface 56 and an oppositely disposed second surface 58. In the depicted embodiment, the substrate 54 is a clear transparent substrate. In another embodiment, the substrate 54 is a translucent substrate. In another embodiment, the substrate 54 is an opaque substrate.

The substrate 54 is a strip of material that has a first axial end 60 and an oppositely disposed second axial end 62. The substrate 54 is folded over itself at fold line 64, which is disposed at the first end portion of the body 42, so that the first and second axial ends 60, 62 of the substrate 54 form the first and second tabs 50, 52, respectively. In the depicted embodiment, the folded substrate 54 adheres to both sides of the indicia member 48 so that the indicia member 48 is captured between the folded substrate 54 at the first end portion 44 of the body 42.

In the depicted embodiment, the second surface 58 of the substrate 54 of the body 42 is at least partially coated with an adhesive layer 66. In one embodiment, the entire surface of the second surface 58 is coated with the adhesive layer 66. The adhesive layer 66 can include a pressure sensitive adhesive.

In one embodiment, the adhesive layer 66 of the tab assembly 40 is a clear, transparent layer so that the indicia member 48 can be easily viewed. In another embodiment, the tab assembly 40 can uses a clear, transparent layer as the adhesive layer 66 and a colored, transparent configuration which can be used to achieve tinting and coloration effects on the indicia member 48. Gradient coloration can also be used to achieve varied desirable effects on the indicia member 48.

The tab assembly 40 includes a release liner 68. The release liner 68 is adapted to cover the adhesive layer 66 disposed on an inner surface 70 of the first tab 50 and the adhesive layer 66 disposed on an interior surface 72 of the second tab 52.

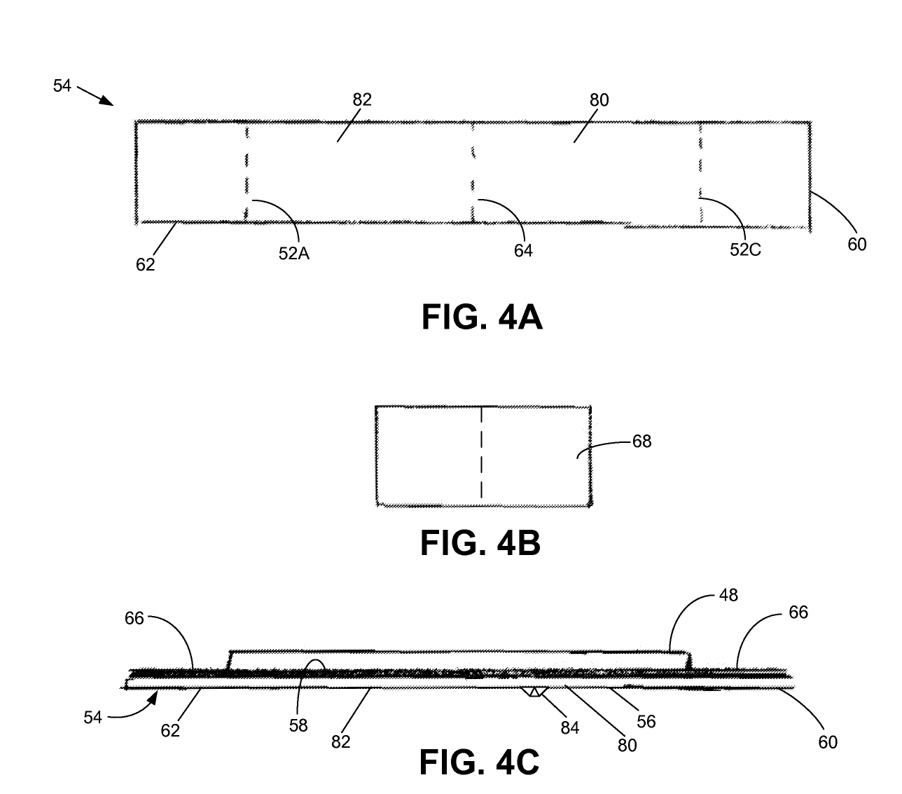

Referring now to FIGS. 4A-4C, a method for assembling the tab assembly 40 will be described. The substrate 54 includes a first portion 80 and a second portion 82. The first portion 80 includes the first axial end 60 while the second portion 82 includes the second axial end 62. The first and second portions 80, 82 are separated by fold line 64. In the depicted embodiment, the fold line 64 is generally halfway between first and second axial ends 60, 62 of the substrate 54.

With the second surface 58 of the substrate 54 facing upward, the indicia member 48 is positioned on the second surface 58 of the substrate 54. With the indicia member 48 disposed on the second surface 58, the substrate 54 is folded over itself at fold line 64 to a folded position so that the second surface 58 of the first portion 80 of the substrate 54 moves in a direction toward the second surface 58 of the second portion 82 of the substrate 54. As the substrate 54 is folded, the first and second axial ends 60, 62 are prevented from coming in contact with each other.

The indicia member 48 is captured between the first and second portions 80, 82 of the substrate by the adhesive layer 66. With the substrate 54 in the folded position, the first and second axial ends 60, 62 of the substrate 54 form the first and second tabs 50, 52 of the tab assembly 40.

The release liner 68 is placed across the exposed adhesive layer 66 on at least one of the first and second tabs 50, 52 of the tab assembly 40. In the depicted embodiment, the release liner 68 is placed across the exposed adhesive layer 66 on the first and second tabs 50, 52 of the tab assembly 40.

In one embodiment, a second indicia member 84 can be affixed to the first surface 56 of the substrate 54. The second indicia member 84 can be affixed to the first surface 56 by an adhesive. The second indicia member 84 can include any one or more of a jewel, a gem, a rhinestone, a button, a bead, a rivet, a stud, etc. In the depicted embodiment, the second indicia member 84 is disposed adjacent the fold line 64. In another embodiment, the second indicia member 84 is disposed on the first surface 56 at a location that is offset from the first tab 50.

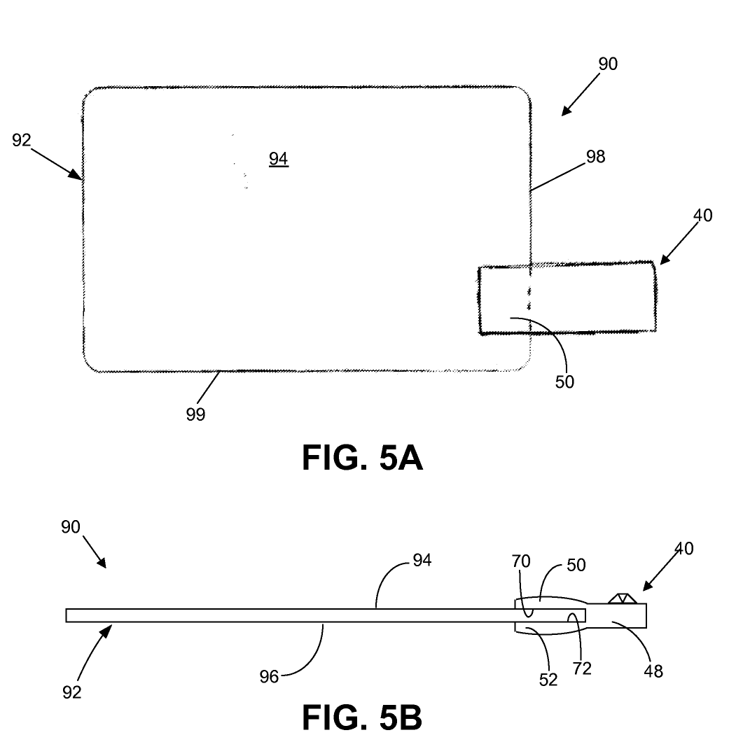

Referring now to FIGS. 5A and 5B, a card assembly 90 is shown. The card assembly 90 includes a card 92 (e.g., a photograph, an identification card, a driver's license, a credit card, a debit card, a gift card, an insurance card, etc.) and the tab assembly 40. The tab assembly 40 is engaged to card 92.

The card 92 includes a first card surface 94 and an oppositely disposed second card surface 96. Tab assembly 40 is attached to the card 92 through the first tab 50 and the second tab 52 of tab assembly 40. In the depicted embodiment, the inner surface 70 of the first tab 50 is attached to the first card surface 94 and the interior surface 72 of the second tab 52 is attached to second card surface 96 of card 92. With the first and second tabs 50, 52 engaged to the card 92, the indicia member 48 extends outwardly from the card 92

The tab assembly 40 can be affixed to various locations around a perimeter of the card 92. In the depicted embodiment of FIG. 5A, the tab assembly 40 is attached to a short side 98 of card 92. In other embodiments, the tab assembly 40 is attached to a long side 99 of card 92.

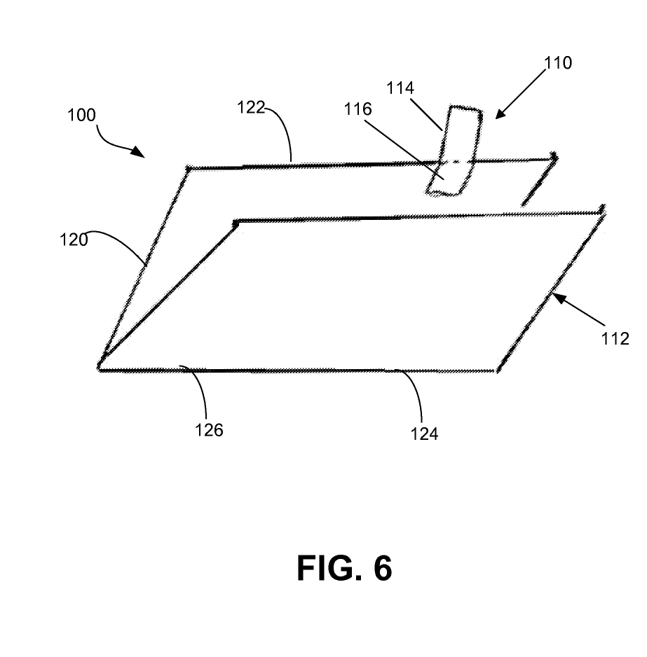

Referring now to FIG. 6, a folder assembly 100 is shown. The folder assembly 100 includes a second tab assembly 110 attached to a file folder 112. The second tab assembly 110 is similar in structure to the tab assembly 10, 40 previously described. It will be understood that the features described with regard to the tab assembly 10, 40 are the same or similar to the features of the second tab assembly 110. The second tab assembly 110 includes an indicia member 114, a first tab 116 and a second tab. The indicia member 114 is connected to the first and second tabs 116. The first and second tabs 116 of the second tab assembly 110 are attached to opposite surfaces of the file folder 112. File folder 112 comprises a short edge 120 and a long edge 122. In one embodiment, the file folder 112 includes a fold 124 at an opposing long edge 126. Attachment of tab assembly 110 to the file folder 112 allows for easy identification of the contents of the file folder 112.

Referring now to FIGS. 1-6, a method for organizing cards and receipts will be described. Some embodiments of the present disclosure include a method of organizing credit cards and receipts of charges therefrom. For example, card assembly 90 (FIG. 5A) can have tab assembly 40 including indicia member 48. The second tab assembly 110 including the indicia member 114 can be attached to the file folder 112 (FIG. 6). Receipts from charges made with the card assembly 90 can be placed into the file folder 112.

In one embodiment, the indicia member 48 of the tab assembly 40 and the indicia member 114 of the second tab assembly 110 are similar in design. In one embodiment the indicia members 48, 114 include a color. In other embodiments the indicia members 48, 114 include logos such as Visa®, MasterCard® or the likes. In other embodiments, the indicia members 48, 114 include at least one of a jewel, a gem, a rhinestone, a bead, a rivet, a stud or the likes.

Other methods embodied in the present disclosure include organizing discount coupons for use in retail stores. In this case, the indicia member 48 would contain a design or logo of the discount store where the discount coupons could be used. This avoids confusion of various coupons once the coupons have been removed from a file.

Various modifications and alterations of this disclosure will become apparent to those skilled in the art without departing from the scope and spirit of this disclosure, and it should be understood that the scope of this disclosure is not to be unduly limited to the illustrative embodiments set forth herein.

What is claimed is:

1. A tab assembly comprising:
an indicia member having a first end and an oppositely disposed second end;
a first tab engaged to the second end of the indicia member;
a second tab engaged to the second end of the indicia member;
an adhesive layer coating at least a portion of the first tab and at least a portion of the second tab; and
a release liner covering the adhesive layer of at least one of the first and second tabs.

2. The tab assembly of claim 1, wherein the adhesive layer is a pressure sensitive layer.

3. The tab assembly of claim 1, wherein the indicia member includes a color, a pattern, a figure, a logo, a symbol, a letter, and a number.

4. The tab assembly of claim 1, wherein the indicia member includes one of a rhinestone, a button, a bead, a rivet, and a stud.

5. The tab assembly of claim 5, wherein the indicia member includes a rhinestone.

6. The tab assembly of claim 1, wherein the release liner covers the adhesive layer of the first and second end tabs.

7. The tab assembly of claim 1, wherein a first fold line is disposed between the first end tab and the indicia member.

8. The tab assembly of claim 7, wherein a second fold line is disposed between the second end tab and the indicia member.

9. A tab assembly comprising:
a body having:
a first end portion, the first end portion including indicium;
a second end portion oppositely disposed from the first end portion, the second end portion including:
a first tab having an outer surface and an oppositely disposed inner surface;
a second tab having an exterior surface and an oppositely interior surface, wherein the inner surface of the first tab faces toward the interior surface of the second tab;
an adhesive layer disposed on the inner surface of the first tab of the body and the interior surface of the second tab; and
a release liner disposed over the adhesive layer on at least one of the inner surface of the first tab and the interior surface of the second tab.

10. The tab assembly of claim 9, wherein the adhesive layer is a pressure sensitive adhesive layer.

11. The tab assembly of claim 9, wherein the indicium of the first end portion includes at least one of a color, a pattern, a figure, a shape, a logo, a symbol, a letter and a number.

12. The tab assembly of claim 11, wherein the indicium of the first end portion includes at least one of a jewel, a gem, a rhinestone, a button, a bead, a rivet and a stud.

13. The tab assembly of claim 9, wherein the indicium of the first end portion is disposed on an indicia member.

14. The tab assembly of claim 13, wherein the indicia member has a thickness in the range of about 0.1 mm to about 2.0 mm.

15. A method of assembling a tab assembly, the method comprising:
providing a substrate including a first portion having a first axial end and a second portion having a second axial end that is oppositely disposed from the first axial end, the substrate including a first surface and an oppositely disposed second surface, wherein the second surface includes adhesive;
positioning an indicia member on the second surface of the substrate;
folding the substrate to a folded position in which the second surface of the first portion of the substrate faces in a direction toward the second surface of the second portion of the substrate, wherein the second surfaces of the first and second axial ends are disconnected so that the first axial end forms a first tab and the second axial end forms a second tab that is adjacent to the first tab in the folded position;
placing a release liner over the second surface of at least one of the first and second tabs.

16. The method of claim 15, wherein the indicia member is captured between the second surfaces of the first and second portions of the substrate.

17. The method of claim 15, wherein the indicia member includes at least one of a color, a pattern, a logo, a symbol, a letter and a number.

18. The method of claim 15, wherein the indicia member has a thickness in a range of about 0.1 mm to about 2.0 mm.

19. The method of claim 15, further comprising applying a second indicia to the first surface of the strip.

20. The method of claim 19, wherein the second indicia includes at least one of a jewel, a gem, a rhinestone, a button, a bead, a rivet and a stud.
